(19) United States
(12) Patent Application Publication
(10) Pub. No.: US 2015/0280227 A1
(43) Pub. Date: Oct. 1, 2015

(54) PREDOPING METHOD FOR AN ELECTRODE ACTIVE MATERIAL IN AN ENERGY STORAGE DEVICE, AND ENERGY STORAGE DEVICES

(71) Applicant: IMRA AMERICA, INC., Ann Arbor, MI (US)

(72) Inventors: Guanghui HE, Ann Arbor, MI (US); Bing TAN, Ann Arbor, MI (US); Zhendong HU, Ann Arbor, MI (US); Yong CHE, Ann Arbor, MI (US)

(73) Assignee: IMRA AMERICA, INC., Ann Arbor, MI (US)

(21) Appl. No.: 14/669,124

(22) Filed: Mar. 26, 2015

Related U.S. Application Data
(60) Provisional application No. 61/971,327, filed on Mar. 27, 2014.

(51) Int. Cl. H01M 4/38; H01M 4/58; H01M 4/485; H01G 9/048; H01G 9/035; H01G 9/042; H01G 9/02; H01M 4/583; H01M 4/04

(52) U.S. Cl. CPC H01M 4/38; H01M 4/583; H01M 4/386; H01M 4/5815; H01M 4/485; H01M 4/5825; H01M 4/049; H01M 4/0419; H01M 4/0416; H01G 9/035; H01G 9/042; H01G 9/02; H01G 9/048; H01M 2004/028

(57) ABSTRACT

A predoping method for a negative electrode active material of an energy storage device, comprising at least one predoping material that can provide an ion that is different from a primary ionic charge carrier for a charging and discharging process of the energy storage device, called non-primary predoping material. The predoping material may be first included in a predoping electrode and later discharged to the negative electrode active material. The predoping material may be first mixed with the negative electrode active material in an electrode fabrication process, and later made to directly contact the negative electrode active material by adding an electrolyte and removing the protective shells of the predoping material. An ion exchanging method is used to exchange a first ion coming from the predoping material for a second ion in an electrode stack.

### FIELD

The present invention is related to a predoping method for an electrode active material of an energy storage device.

### BACKGROUND

The following patent, published patent applications, and non-patent publications are pertinent to the present disclosure:
Reference 1: JP2006-286919: LITHIUM ION CAPACITOR;
Reference 2: JP5-234621A: NONAQUEOUS ELECTROLYTE SECONDARY BATTERY AND ITS MANUFACTURE;
Reference 3: JP2007-324271A: ELECTROCHEMICAL CAPACITOR AND ITS MANUFACTURING METHOD;
Reference 4: JP10-294104A: MANUFACTURE OF ELECTRODE OF LITHIUM SECONDARY BATTERY;
Reference 5: JP2002-373657A: METHOD FOR PRODUCING NEGATIVE ELECTRODE FOR NONAQUEOUS ELECTROLYTE SECONDARY BATTERY AND THE NONAQUEOUS ELECTROLYTE SECONDARY BATTERY;
Reference 6: EP20110816478: PREDOPING METHOD FOR LITHIUM, METHOD FOR PRODUCING ELECTRODES, AND ELECTRIC POWER STORAGE DEVICE USING THESE METHODS;
Reference 7: Electrochemical Performance of Porous Carbon/Tin Composite Anodes for Sodium-Ion and Lithium-Ion Batteries, Y. Xu, Y. Zhu, Y. Liu, C. Wang, Adv. Energy Mater. 2013, 3, 128-133

Over the last few decades, Li-ion batteries have been widely employed in portable electronic devices, are expected to power electric vehicles and even to be used as energy storage components in grid harvesting from renewable energy sources. Taking into account that the lithium resource is limited and unevenly distributed around the world, the cost for future large-scale commercial manufacture of Li-ion batteries would become a major issue. In this regard, other metal-ion batteries like rechargeable sodium, magnesium, calcium and aluminum-ion batteries are garnering more interest as candidates for a post-lithium system. (The metal-ion here indicates the primary charge carrier for the chemical and electrical energy conversion.)

For energy storage devices applying these metal ions, electrolytes are known to decompose and form passivating solid electrolyte interfaces (SEIs) on the surfaces of negative or positive electrodes. The SEIs play an important role in the metal-ion batteries as they protect the electrolyte from decomposing and increase the cell internal resistances. The formation of SEIs is accompanied by irreversible decomposition of electrolyte solvent and consumption of ions (energy) that are normally stored in the positive electrode and electrolyte. On the other hand, some metal-oxide materials are being developed as high energy density negative electrode materials for Li-ion cells, and they can undergo a reduction process with high irreversible loss of Li⁺. For example, SnO₂ undergoes a reduction at the potential range of 1.5 V to 1 V vs Li⁺/Li, a SEI formation at the potential range of 0.8 V to 0.5V vs Li⁺/Li, and a reversible alloying reaction at the potential range of 0.8 to 0 V vs Li⁺/Li with Li⁺ ions. (Reference 7).

In order to compensate for these irreversible lithium ion consumptions to achieve higher reversible capacities, methods of predoping the negative electrodes of Li-ion cells by using extra pieces of lithium metal have been disclosed. In these methods, lithium ions are electrochemically made to be absorbed and supported by a negative active material to lower its potential in a preliminary step, whereby the irreversible losses of lithium ions are prevented and the energy density of Li-ion cells can be significantly increased. These methods enable the possibility of using negative electrode active materials with high irreversible capacity loss and also hybrid energy storage devices. Lithium ion capacitor (LIC) is a hybrid of electrochemical double layer capacitor (EDLC) and lithium ion battery (LIB). The positive electrode active material of LIC is usually a high surface area activated carbon that stores/releases ions through a physical adsorption/desorption process, and the negative electrode active material is a LIB negative electrode active material that stores/releases ions through a Li ion insertion/extraction process. Because of the low voltage plateau of the negative electrode, the cell voltage of LIC can reach 3.8 V, which is 1.5 times of the cell voltage of traditional carbon-carbon symmetric EDLC (2.5 V). However, in the current technologies, the activated carbon in the positive electrode of a LIC has lower capacity compared to a battery positive electrode active material. The irreversible capacity loss on the negative electrode can further reduce a large portion of total usable energy. Therefore, a predoping process on the negative electrode is necessary to reduce the irreversible capacity loss and improve the energy density of a LIC.

Reference 1 discloses a predoping technique, in which the battery electrode layers are formed on current collectors provided with through-pores, and a lithium foil is arranged on the outside surface of the electrode stack. By short-circuiting the lithium metal and a negative electrode arranged in the battery, lithium ions pass through the through-pores of the current collector that are filled with an electrolytic solution and reach layers of negative electrodes, thus all of the negative electrodes are doped with the ions. Further, a technique has been disclosed in which lithium metal powder is mixed with an electrode, or lithium metal powder is uniformly dispersed on a negative electrode as described in Reference 2. After filling a solution therein, a local electrochemical cell is formed on the electrode, thereby the lithium ions are uniformly doped in the electrode active material. Further, Reference 3 discloses a technique in which polymer-coated Li fine particles are mixed with a negative electrode to produce a negative electrode. After assembling a cell, the negative electrode is impregnated with an electrolytic solution, and the polymer of the polymer-coated Li fine particles is dissolved in the electrolytic solution to cause electric conduction (short-circuiting) between the Li metal particles and the carbon of the negative electrode, whereby the carbon of the negative electrode is doped with Li ions.

On the other hand, other techniques are known, such as a technique in which an electrode is produced by immersing an electrode material in a solution in which n-butyllithium is dissolved in an organic solvent such as hexane, and by reacting the n-butyllithium with the electrode material (Reference 4); a technique in which lithium is reacted with graphite while the lithium is in a gas phase by an approach called a Tow-Bulb method, thereby causing graphite to contain lithium (Reference 5); a technique in which lithium is mechanically alloyed through a mechanical alloying process (Reference 5); and a technique in which a lithium-dopable electrode active material and lithium particles are mixed with kneading in an organic solvent, whereby the electrode active material is doped with lithium and then the mixture is cast into an electrode (Reference 6).

### SUMMARY

In one aspect, a predoping method in an energy storage device is a method that is used to compensate the irreversible loss of an electrode active material, such as a positive electrode and/or a negative electrode active material, in a preliminary step in order to improve the reversible energy available during the charging and discharging processes of the energy storage device.

In conventional predoping processes, the predoping material includes the same type of ion as a primary ionic charge carrier utilized during a charging and discharging process of the energy storage device, herein called a “primary predoping ion or material”. However, some of these ion-comprising predoping materials, such as the materials comprising lithium, may be limited resources, (which is also the reason that non-lithium metal ion batteries are attracting research interest) and reactive to the atmosphere and thus difficult to handle as a metal. For negative electrode active materials with high irreversible capacity loss, such as oxide-based materials, the quantity of lithium required for predoping is large, therefore, the cost of raw predoping material and handling may contribute a big portion of the final cost of the energy storage device.

The inventors of the present application discovered that even with a predoping material that can provide an ion that is different from the primary ionic charge carrier for the charging and discharging process of the energy storage device, herein called a “non-primary predoping material”, the negative electrode active material can still be predoped. The irreversible capacity loss of electrode materials can be compensated by non-primary predoping materials of other more abundant metals, such as Na, K, Mg, Ca, Zn, Mn, Cu, Ni, Pb, Ag, Al, and the like. Besides Li-ion cells, the predoping method of the present invention may also be applied to other metal-ion cells, such as Na-ion cells, Mg-ion cells and Al-ion cells by using a predoping material that can provide a different metal ion than the primary charge carriers.

According to one aspect of the present invention, inexpensive and easy-to-handle predoping materials can be used to reduce the production cost for these metal-ion energy storage devices.

According to one aspect of the present invention, the electrochemical properties of electrode material components, including SEI and oxide reduction products can be modified by controlling the type, quantity, and addition sequences of predoping materials to achieve improved electrochemical performances. A predoping material can be selected to form an improved SEI morphology that is beneficial for electrolyte stability and fast ion diffusion. A predoping material can also be selected to form the reduction products that remain in the electrode material as better stress buffering components compared to primary predoping material. For example, SnO₂ undergoes a reaction of SnO₂+Li=>Li₂O+Sn during the first cycle of charging (or predoping), and Li₂O is produced to form a matrix to buffer the Sn particle expansion during the charge/discharge cycling. By introducing a different predoping material, the reduction can undergo a different route, such as SnO₂+2M=>M₂Oₓ+Sn, (e.g., M=Na, K, and the like, x=1; M=Ca, Mg, Zn, Ni, Zn, Pb, and the like, x=2; M=Al, and the like, x=3.) and the stress buffer component of M₂Oₓ may have different lattice parameters, micromechanical properties, or electrochemical stability, which may help in achieving better cycling stability of the electrochemical cells.

In one aspect, the present invention features: an electrode active material of an energy storage device is predoped by at least one non-primary predoping material that can provide an ion that is different from a primary ionic charge carrier utilized for a charging and discharging process of the energy storage device.

By doing so, the cost of the predoping process can be reduced, and the electrochemical properties of electrode material components can be modified.

In at least one embodiment, a predoping technique is conducted in an energy storage device, comprising:
a predoping unit, comprising:
   a primary predoping electrode comprising a primary predoping material;
   at least one non-primary predoping electrode comprising at least one non-primary predoping material; and
   an absorbing electrode comprising an absorbing material;
an energy storage unit, comprising:
   a positive electrode comprising a positive electrode material; and
   a negative electrode comprising a negative electrode material;
a separator; and
an electrolyte,
   wherein, a separator is inserted in between the electrodes, and the predoping unit, the energy storage unit and the separator are impregnated with the electrolyte.

In an exemplary embodiment, said absorbing electrode is placed on the opposite end of the energy storage unit to the primary predoping electrode. In an exemplary embodiment, the primary and non-primary predoping electrode, the positive electrode and the negative electrode, and the absorbing electrode are formed with through-pores that extend from one surface to the other to allow for an ionic flow across the energy storage device.

In at least one embodiment, a predoping technique includes:
a. introducing at least one non-primary predoping material into close proximity to negative electrode active material; and
b. reacting the at least one non-primary predoping material with the negative electrode active material,

wherein the introducing process may be performed by spraying, soaking, mixing, or mechanical alloying.

In an exemplary embodiment, the non-primary predoping material may be in a gas, liquid, or fine solid powder that may be coated by a polymer protective shell.

In an exemplary embodiment, the protective shells for different predoping materials may have a different dissolution time in a solvent.

In at least one embodiment, the present invention provides a method of exchanging a first ion for a second ion in an electrolyte, comprising:
a. providing a source electrode, including a source material that can provide the second ion;
b. providing an absorbing electrode, including an absorbing material that can absorb the first ion; and
c. electrically discharging the source electrode to the absorbing electrode in the electrolyte,

wherein the absorbing material may be a positive or negative electrode active material of a secondary metal-ion energy storage device, a positive or negative electrode active material of primary metal-ion energy storage devices, or an electrode material that has a large irreversible reaction capacity towards said first ion.

In an exemplary embodiment, the absorbing material is selective in absorbing the first ion compared to the second ion.

In at least one embodiment, the present invention provides an energy storage device, comprising:
a positive electrode comprising a positive electrode active material that stores energy through faradic and/or non-faradic reactions;
a negative electrode comprising a negative electrode active material that stores energy through faradic and/or non-faradic reactions;
an electrolyte; and
a separator,

wherein, at least one of the positive and negative electrode active material is predoped by at least one non-primary predoping material.

### BRIEF DESCRIPTION OF DRAWINGS

FIG. 1 is a sectional view schematically showing an energy storage device as a preferred embodiment of the present invention;

FIG. 2 is a sectional view schematically showing a structure of a portion of the energy storage device of FIG. 1 as a preferred embodiment of the present invention;

FIG. 3 is a sectional view schematically showing a predoping process inside an energy storage device applying a predoping electrode as a preferred embodiment of the present invention;

FIG. 4 is a sectional view schematically showing the exchanging process as a preferred embodiment of the present invention; and

FIG. 5 is a sectional view schematically showing a predoping technique applying coated solid powders as a preferred embodiment of the present invention.

### EXPLANATION OF SYMBOLS

100: energy storage device, 102: negative electrode, 104: negative lead tab, 106: positive electrode, 108: positive lead tab, 110: electrolyte, 112: separator, 114: safety vent, 116: positive electrode cap, 118: positive temperature coefficient (PTC) device, 120: gasket, 122/124: insulators, 126: battery housing, 128: electrode stack,
200: electrode laminate unit, 202: separator, 204: negative electrode material, 206: current collector, 208: positive electrode material, 210: negative electrode, 212: positive electrode, 214: electrolyte.
300: an energy storage device, 302: energy storage unit, 304: current collector, 306: primary predoping material, 308: separator, 310: non-primary predoping material, 312: negative electrode material, 314: positive electrode material, 316: primary predoping electrode, 318: non-primary predoping electrode, 320: negative electrode, 322: positive electrode, 324: electrolyte, 406: absorbing material, 414: absorbing electrode, 326: predoping unit.
400: schematic exchanging process, 402: current collector, 404: source material, 406: absorbing material, 408: source electrode, 410: electrolyte, 412: electrode stack, 414: absorbing electrode, C1: cation 1, C2: cation 2, e⁻: electron.
500: a positive or negative electrode with a predoping unit, 502: current collector, 504: primary predoping material, 506: primary predoping material protective shell, 508: non-primary predoping material, 510: non-primary predoping material protective shell, 512: negative electrode active material

### DETAILED DESCRIPTION OF INVENTION

In one aspect, the present invention relates to a predoping method for an electrode active material using at least one non-primary predoping material that can provide an ion that is different from a primary ionic charge carrier utilized for a charging and discharging process of an energy storage device. In another aspect, the present invention relates to energy storage devices involved with the proposed predoping method.

### Energy Storage Device and Electrode Active Material

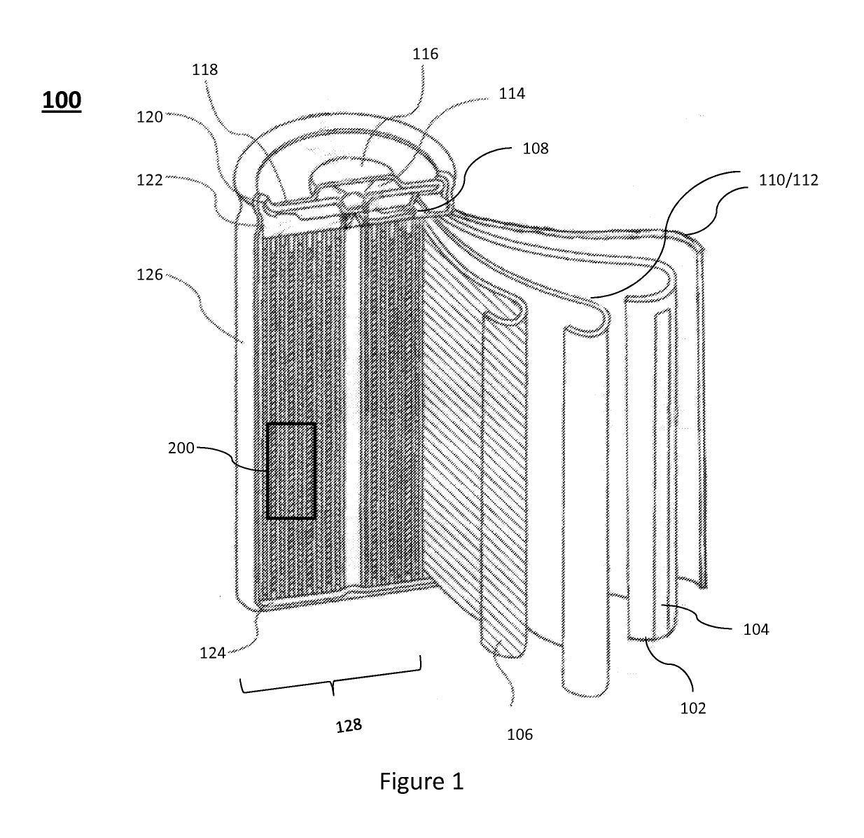

Note that herein, the term “energy storage device” may be a battery or an electrochemical capacitor that stores and releases electrical energy by a charging and discharging process of an ionic charge carrier in an electrolyte between the positive electrode and negative electrode. Shown in FIG. 1 is an example of energy storage device 100 and includes negative electrode 102, negative lead tab 104, positive electrode 106, positive lead tab 108, electrolyte 110, separator 112, safety vent 114, positive electrode cap 116, positive temperature coefficient (PTC) device 118, gasket 120, insulators 122 and 124, and battery housing 126. The positive electrode and the negative electrode are arranged alternatively with the separator interposed in between into an electrode stack 128. The electrolyte is impregnated into the separator and the pores inside the negative electrode and the positive electrode. Although the rechargeable cell is illustrated as a cylindrical structure, any other shape, such as prismatic, aluminum pouch, or coin type may be used.

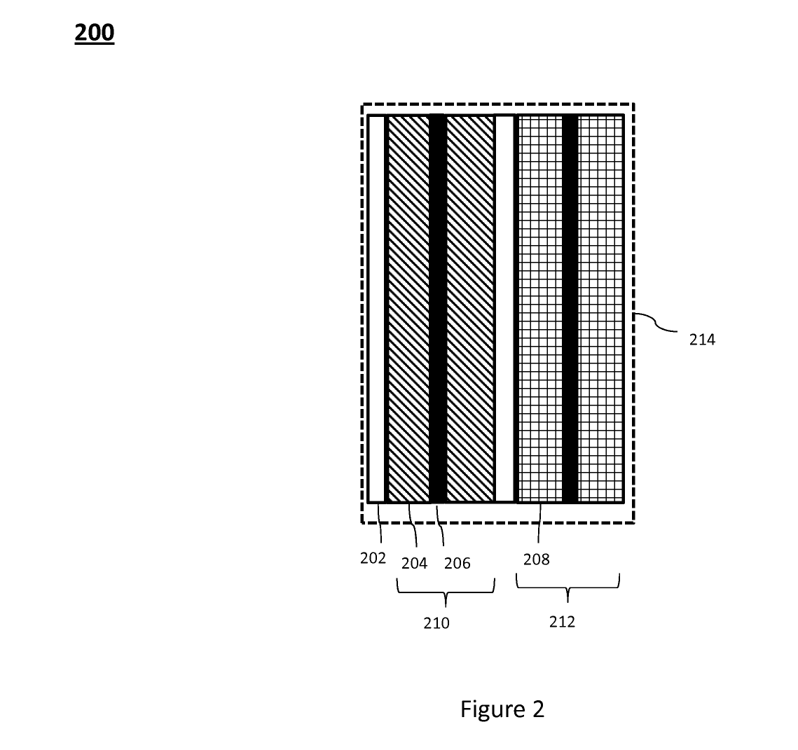

FIG. 2 is an electrode laminate unit 200 of the energy storage device in FIG. 1 in more detail. A positive electrode 212 and a negative electrode 210 are stacked together to face each other with a separator 202 interposed in between and soaked in an electrolyte 214. The positive electrode may be formed by applying a positive electrode material 208 onto one surface or both surfaces of a current collector 206 or made of only positive electrode material or negative electrode material. The negative electrode may be formed by applying a negative electrode material 204 onto one surface or both surfaces of another current collector or made of only the negative electrode material. The separator includes a porous membrane that electrically separates the negative electrode from the positive electrode, while permitting ions to flow across. A separator may not be required if the positive and negative electrodes can be placed spatially separated from each other. The materials for the separator may be selected from nonwoven fibers (e.g. nylon, cotton, polyesters, glass), polymer films (e.g., polyethylene (PE), polypropylene (PP), poly(tetrafluoroethylene) (PTFE), cellulose fibers, polyvinylidene fluoride (PVDF), and poly(vinyl chloride) (PVC), and naturally occurring substances (e.g., rubber, asbestos, wood, and sand). The current collector 206 is an electrically conductive substrate for electrode materials, and may be made of steel, copper, nickel, iron, titanium, graphite, carbon black, carbon nanotubes, graphene, conductive polymer, or the like. The form of the current collector may be a sheet, plate, foil, mesh, expanded metal, felt, or foam shape. The electrolyte is impregnated into the separators, the pores of positive and negative electrode materials, and the through-pores of current collectors if the current collectors are formed with through-pores. The solvent of the electrolyte has at least one component selected from an organic-based liquid, an ionic liquid, a polymer gel or a solid-state solvent. A suitable organic solvent may comprise hexane, tetrahydrofuran (THF), propylene carbonate (PC), ethylene carbonate (EC), diethyl carbonate (DEC), and dimethyl carbonate (DMC), but is not limited thereto. A suitable ionic liquid may comprise ethyl-3-methylimidazolium bis(trifluoromethylsulfonyl)imide (EMIMTFSI), 1-ethyl-3-methylimidazolium bis(fluorosulfonyl)imide (EMIMFSI), N-methyl-N-propylpyrrolidinium bis(fluorosulfonyl)imide (PYRFSI), and the like. A salt is ionized in the solvent of the electrolyte to be used as the primary charge carrier for the charging and discharging process between the positive and negative electrodes of the energy storage device. A suitable primary ionic charge carrier may be selected from Li⁺, Na⁺, K⁺, Mg²⁺, Ca²⁺, Zn²⁺, or Al³⁺.

The positive electrode material and the negative electrode material may include positive and negative electrode active materials, an electrically conductive additive, and a polymer binder. The electrical conductive additive in the positive and negative electrodes is used to improve the electric conductivity of the layer of electrode material to facilitate the electron transport between the particles of the negative electrode active material and between the current collector and the electrode active particles, and may be selected from carbon black, graphite, carbon nanotube, graphene and other nanocarbons. The polymer binder in the positive and negative electrodes is used to bind the particles of electrode active material and conductive additives together to ensure the mechanical integrity of the electrode film and good electrical contact among electrode active material particles, conductive additives and current collectors. Polymer binders may be selected from polytetrafluoroethylene (PTFE), polyvinylidene fluoride (PVDF), carboxymethyl cellulose (CMC), poly(acrylic acid) (PAA), styrene-butadiene rubber (SBR), Alginic acid and the like. Both the electrically conductive additive and the polymer binder generally are not electrochemically-active during the cycling of the energy storage device, so they are not the electrode active materials in the positive and negative electrode material.

The positive and negative electrode active materials are together called the electrode active materials. They are capable of reversibly supporting the primary ionic charge carrier and having irreversible reactions with the ions from non-primary predoping materials to form stable SEIs and reduced products. The electrode active material may be a positive electrode active material that is selected from sulfur or an air catalyst. The electrode active material may be a carbonaceous material, such as graphite, hard carbon, soft carbon, amorphous carbon, carbon nanotubes, graphene, aligned carbon nanotubes, carbon nanoparticles, or carbon nanocrystals. It may also be selected from a metal of Mg, Ca, Sr, Si, Ge, Sn, Sb, Zn, Al, In, Ga, or Bi. It may also be a metal dichalcogenide, metal trichalcogenide, metal oxide, alkaline-metal impregnated metal oxide, metal sulfide, metal fluoride, metal phosphate, metal carbonate, alkaline-metal impregnated metal phosphate, metal nitrate, or metal nitride that comprises a metal selected from Mg, Ca, Sr, Ti, Cr, Mn, Fe, Co, Ni, Cu, Zn, Nb, Mo, W, Al, Ga, In, Si, Ge, Sn, Pb, Sb, and Bi.

### Predoping Process and Predoping Material

The term “doping” is a process, in which electrons and ions are released from a source material, transported through a conductor and an electrolyte, and recombine on a material to be doped through electrochemical reactions. The term “predoping” for an electrode active material means that the electrode active material is doped in a formation step before the normal operation of an energy storage device. The source material of a predoping process is called the predoping material, which can be a metal, a metal alloy, a salt or an electrode active material that is capable of providing an ion for predoping. For an example of predoping with Li ions, besides metallic Li metal, Li₃Al alloys and other chemical lithiation agents, such as n-butyl lithium, LiBH₄, LiH, and Li₃N that have lower electrochemical potentials than the electrode active material can also be used as predoping materials. In the predoping method of the present invention, at least one non-primary predoping material that can provide an ion that is different from a primary ionic charge carrier utilized for a charging and discharging process of the energy storage device is used to predope the electrode active materials. However, primary predoping material that can provide an ion that is the same as the primary ionic charge carrier utilized for the charging and discharging process of the energy storage device may also be included in the predoping process. During the predoping process, more than one type of non-primary predoping material may be added in sequence for different irreversible reactions of the predoping process, such as SEI formation and oxide reduction.

Different predoping techniques may be applied to realize the predoping processes. Generally the predoping material may be introduced to the electrode active material to be predoped by an electric field, a concentration gradient, a mechanical force such as spraying, mixing, kneading or alloying, or by heat evaporation or sputtering. For examples, the predoping materials may be pasted onto a current collector as a predoping electrode and placed at the end of an electrode stack which will be later used as an energy storage device. An external voltage is utilized to drive the ions of predoping materials into the stack and predope the layers of electrode active materials. A solid predoping material may also be pulverized and mixed with the electrode active material during the electrode slurry making process or sprayed onto the surface of formed positive or negative electrodes. After adding an electrolyte to the electrodes, the ionic conductive path is built, and the electrode active material is predoped. For other predoping techniques, the predoping material may be a gas created by heating or sputtering and the electrode active material is placed in the gas and therefore predoped. The predoping material may be a soluble salt in a solvent and the electrode active material can be added into the solution while stirring and therefore predoped. For the above two techniques, more than one predoping source material may be added into the predoping process by changing the gas source or salt in the solution.

After utilizing a non-primary predoping material in the predoping process, the ions of non-primary predoping material remaining on the electrode active materials may cause unfavorable side reactions when they are used in an energy storage device. A rinsing or ion exchanging step may be applied to remove the ions of non-primary predoping material on this material. For predoping processes that happen outside the battery housing, the electrode active material may be retrieved from the predoping chamber, such as a reaction flask or gas chamber, later rinsed in a solvent and let dry. For predoping processes that happen inside the battery housing, the electrolyte, which is the ionic conductive medium, may not easily be removed. An electrochemical ion-exchanging method may be applied to exchange for the ions of the primary predoping material as discussed in the following example.

### Predoping Techniques

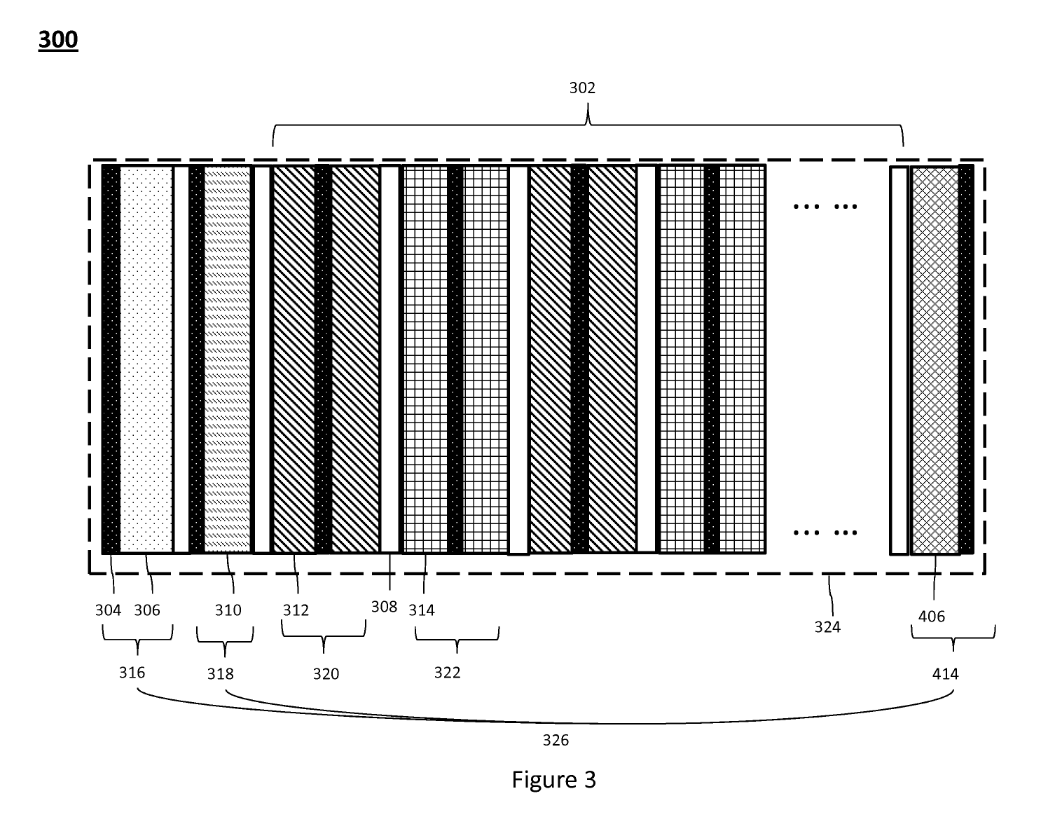

FIG. 3 is a sectional view schematically showing a predoping process inside an energy storage device applying a predoping electrode as a preferred embodiment of the present invention. 300 is an energy storage device, comprising a predoping unit 326, an energy storage unit 302, an electrolyte 324 and a separator 308. The predoping unit further comprises: a primary predoping electrode 316 comprising a primary predoping material 306, at least one non-primary predoping electrode 318 comprising at least one non-primary predoping material 310, an absorbing electrode 414 comprising an absorbing material 406. The energy storage unit further comprises a positive electrode 322 comprising a positive electrode material 314, a negative electrode 320 comprising a negative electrode material 312. The predoping electrode and absorbing electrode may be placed at one end of energy storage unit, facing the last electrode of the energy storage unit, or may be inserted in the middle of the energy storage unit. Each electrode in the energy storage unit and predoping unit, including positive electrode, negative electrode, primary predoping electrode, non-primary predoping electrode, and absorbing electrode is formed with through-pores that extend from one surface to the other to allow for an ionic flow across the energy storage device. The separator is inserted between different electrodes to electrically insulate different electrodes while permitting ionic flow. A separator may not be required if the positive and negative electrodes can be placed spatially separated from each other. The electrolyte is impregnated into the pores of the electrode materials, separators and the through-pores of the current collectors as a carrier for both the predoping process and the charging and discharging process of the energy storage device. The anions in the electrolyte are selected to form dissolvable salts with the ions of both primary predoping material and non-primary predoping material. Suitable anions may be selected from hexafluorophosphate (PF₆⁻), tetrafluoroborate (BF₄⁻), perchlorate (ClO₄⁻), bis(oxalato)borate (BOB⁻), bis(Trifluoromethanesulfonyl)Imid (TFSI⁻), but are not particularly limited to the above mentioned ions.

In one exemplary embodiment, a metal-oxide material is used as the negative electrode active material and the electrolyte initially comprises an ion of a non-primary predoping material. In the first step, the negative electrode active material is predoped by the non-primary predoping material until the metal-oxide material is fully reduced into a metal and an oxide of the non-primary predoping material. In the second step, the ions in the electrolyte are fully exchanged for the ions of a primary predoping material by an ion exchanging process.

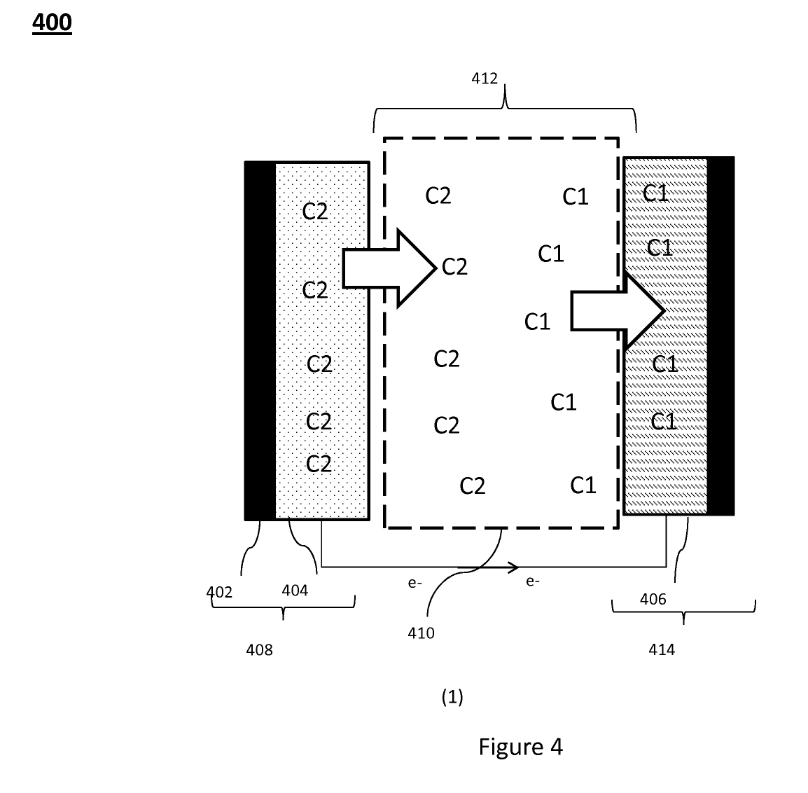

FIG. 4 is a sectional view schematically showing the ion exchanging process as a preferred embodiment of the present invention. The exchanging process proceeds as a first ion C1 is gradually replaced by a second ion C2 in an electrode stack 412 that is permeable to ionic flow. A source electrode 408 comprises a source material 404, which may be a predoping material that is capable of releasing the second ion C2 into the electrolyte. An absorbing electrode 414 comprises an absorbing material 406 that is capable of storing the first ion C1. The absorbing material is selected to be preferential in accepting C1 ions compared to C2 ions at a certain potential. Since the absorbing material does not need to release ions back into the electrolyte, even electrode active material that has a large irreversible loss in reacting with C1 ions can be used. The absorbing material may be selected from, but not limited to the electrode materials for primary metal-ion batteries, electrode materials with high irreversible capacity loss, and electrode materials for secondary metal-ion batteries. The source electrode and absorbing electrode are preferably to be placed on the opposite ends of the electrode stack as shown in the schematic figure, so that the interference of the second C2 ions on the absorption of C1 ions can be minimized.

Here in the exemplary embodiment, the source electrode is the primary predoping electrode 316. After the exchanging process is finished, the negative electrode active material is doped with the primary predoping material until the SEI is fully formed and the potential of the negative electrode is reached at a desired value. A constant current (CC) and constant voltage (CV) control technique may be applied to regulate the electrochemical reaction rate during the predoping process. In the CC step, the final cutoff voltage for the negative electrode may be controlled at a potential plateau of interest. Current density may be set at a value that is acceptable to the kinetics of ion diffusion and interfacial transportation to avoid over-potential or undesired side reactions. In the CV step, the floating voltage may be held at the same potential plateau until a minimum current is passing through to guarantee a thorough reaction.

After the predoping process is finished, the primary and non-primary predoping materials are preferably all consumed and only the current collectors are left. Later the bare current collectors and absorbing electrode may be removed from the energy storage device. The initial loading of primary and non-primary predoping material can be calculated based on the consumption of ions at designated steps of predoping process for each predoping material. The quantity of consumption can be predetermined in separated predoping tests using the same negative electrode active material. The initial quantity of ions dissolved in the electrolyte should also be taken into consideration as they will also participate in the predoping process. The loading of absorbing material may be calculated based on its capacity for the ions to be absorbed.

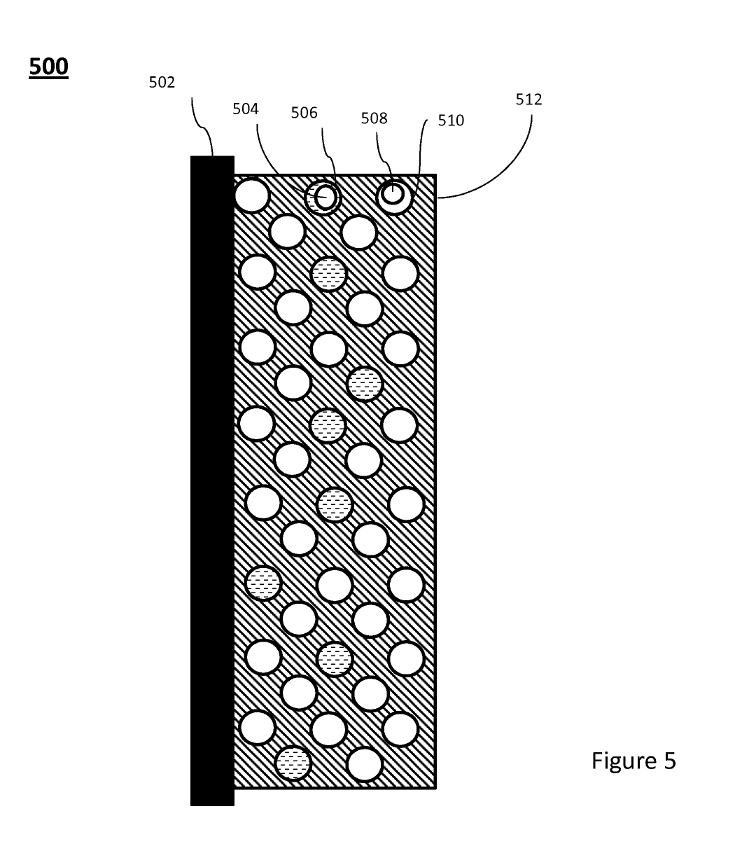

FIG. 5 is a sectional view schematically showing a predoping technique applying coated solid powder as an exemplary embodiment of the present invention. The solids of the primary predoping material 504 and at least one non-primary predoping material 508 were firstly processed as grains, rods, cubes or other shapes in size range of 1 μm to 100 μm, and more preferably 10 to 50 μm, later mixed homogenously with the electrode active materials 512 and other additives in an organic solvent such as N-Methylpyrrolidone (NMP), Toluene, or xylene then casted on a current collector 502 into an electrode. To protect the highly reactive predoping materials, the fabrication process may be conducted in an inert environment and the powders of predoping materials may be coated with a polymer or inorganic protective shells 506 and 510. The protective shells may later be removed by solvent dissolution, heat or vacuum evaporation, or by mechanical crushing to expose the metallic cores of the predoping materials. By adding an electrolyte, the ionic conduction path between the predoping materials and the electrode active materials is built and the electrode active material is predoped.

The predoping materials may be activated in sequence by coating with protective shells of different properties, such as thickness or solubility in a designated solvent to obtain different dissolution times and therefore different activation times. The loading of non-primary predoping material should not exceed the amount that reversible reactions between ions of non-primary predoping material and electrode active materials happen at low potentials. In one exemplary embodiment, both non-primary and primary predoping materials are mixed homogeneously in the electrode matrix. The non-primary predoping material may be coated by a thinner polymer shell, while the primary predoping material may be coated with a thicker polymer shell so that after a solvent is added to the mixture, the electrode active material will be predoped by the non-primary predoping material with a thinner shell first to be fully reduced and formed with SEIs. The primary predoping material later comes into the process by clearing the ions of non-primary predoping material in the electrolyte and doping the electrode active material into a lower potential.

It is understood that the described embodiments are not mutually exclusive, and elements, components, materials, or steps described in connection with one exemplary embodiment may be combined with, or eliminated from, other embodiments in suitable ways to accomplish desired design objectives.

Reference herein to “one embodiment” or “an embodiment” means that a particular feature, structure, or characteristic described in connection with the embodiment can be included in at least one embodiment. The appearances of the phrase “in one embodiment” in various places in the specification are not necessarily all referring to the same embodiment, nor are separate or alternative embodiments necessarily mutually exclusive of other embodiments. The same applies to the term “implementation.”

As used in this application, the word “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion.

Additionally, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Unless explicitly stated otherwise, each numerical value and range should be interpreted as being approximate as if the word “about” or “approximately” preceded the value of the value or range.

It should be understood that the steps of the exemplary methods set forth herein are not necessarily required to be performed in the order described, and the order of the steps of such methods should be understood to be merely exemplary. Likewise, additional steps may be included in such methods, and certain steps may be omitted or combined, in methods consistent with various embodiments.

Although the elements in the following method claims, if any, are recited in a particular sequence with corresponding labeling, unless the claim recitations otherwise imply a particular sequence for implementing some or all of those elements, those elements are not necessarily intended to be limited to being implemented in that particular sequence.

No claim element herein is to be construed under the provisions of 35 U.S.C. §112, sixth paragraph, unless the element is expressly recited using the phrase “means for” or “step for.”

It will be further understood that various changes in the details, materials, and arrangements of the parts which have been described and illustrated in order to explain the nature of described embodiments may be made by those skilled in the art without departing from the scope as expressed in the following claims.

What is claimed is:

1. An electrode active material of an energy storage device, said electrode active material is predoped by at least one predoping material that can provide an ion that is different from a primary ionic charge carrier utilized for a charging and discharging process of the energy storage device.

2. The electrode active material of claim 1, wherein said predoping material can provide an ion that is the same as the primary ionic charge carrier utilized for the charging and discharging process of the energy storage device.

3. The electrode active material of claim 1, wherein said predoping material comprises a metal that provides an ion for predoping.

4. The electrode active material of claim 3, wherein said metal comprises at least one metal selected from Li, Na, K, Mg, Ca, Zn, Mn, Co, Cu, Ni, Pb, Ag, or Al.

5. The electrode active material of claim 1, wherein said primary ionic charge carrier comprises at least one ion selected from Li⁺, Na⁺, K⁺, Mg²⁺, Ca²⁺, Zn²⁺, or Al³⁺.

6. The electrode active material of claim 1, wherein said electrode active material is selected from carbonaceous material, graphite, hard carbon, soft carbon, amorphous carbon, carbon nanotubes, graphene, aligned carbon nanotubes, carbon nanoparticles, or carbon nanocrystals.

7. The electrode active material of claim 1, wherein said electrode active material is a positive electrode active material that is selected from sulfur or an air catalyst.

8. The electrode active material of claim 1, wherein said electrode active material is selected from a metal or a metal compound.

9. The electrode active material of claim 8, wherein said metal comprises Mg, Ca, Sr, Si, Ge, Sn, Sb, Zn, Al, In, Ga, or Bi.

10. The electrode active material of claim 8, wherein said metal compound is a compound of metal comprising Mg, Ca, Sr, Ti, V, Cr, Mn, Fe, Co, Ni, Cu, Zn, Zr, Nb, Mo, W, Al, Ga, In, Si, Ge, Sn, Pb, Sb, or Bi.

11. The electrode active material of claim 8, wherein said metal compound comprises metal dichalcogenide, metal trichalcogenide, metal oxide, alkaline-metal impregnated metal oxide, metal sulfide, metal fluoride, metal phosphate, metal carbonate, alkaline-metal impregnated metal phosphate, metal nitrate, or metal nitride.

12. An energy storage device, comprising:
a predoping unit, comprising:
a primary predoping electrode comprising a primary predoping material;
at least one non-primary predoping electrode comprising at least one non-primary predoping material; and
an absorbing electrode comprising an absorbing material;
an energy storage unit, comprising:
a positive electrode comprising a positive electrode material; and
a negative electrode comprising a negative electrode material;
a separator; and
an electrolyte,
wherein, the predoping unit, the energy storage unit and the separator are impregnated with the electrolyte.

13. The energy storage device of claim 12, wherein the primary and non-primary predoping electrode, the positive electrode and the negative electrode, and the absorbing electrode are formed with through-pores that extend from one surface to the other to allow for an ionic flow across the energy storage device.

14. The energy storage device of claim 12, wherein said absorbing electrode is placed on the end of the energy storage unit opposite to the primary predoping electrode.

15. The energy storage device of claim 12, wherein said absorbing material is a positive or negative electrode material of a secondary energy storage device.

16. The energy storage device of claim 12, wherein said absorbing material is a positive or negative electrode material of a primary energy storage device.

17. The energy storage device of claim 12, wherein said absorbing material is an electrode material that has a large irreversible reaction capacity towards the ion of non-primary predoping material.

18. The energy storage device of claim 12, wherein said absorbing material is selective to be preferential in absorbing the ion of non-primary predoping material compared to the ion of primary predoping material.

19. The energy storage device of claim 12, wherein an anion in the electrolyte is selected to form dissolvable salts with the ions of both the primary and non-primary predoping materials.

20. A predoping method for an electrode active material of an energy storage device, comprising:
a. introducing at least one non-primary predoping material into close proximity of the electrode active material; and
b. reacting said at least one non-primary predoping material with said electrode active material.

21. The predoping method of claim 20, wherein said introducing process is performed by at least one process of spraying, soaking, mixing or by mechanical alloying.

22. The predoping method of claim 20, wherein a primary predoping material is introduced for predoping.

23. The predoping method of claim 20, wherein said predoping material is a solid powder.

24. The predoping method of claim 23, wherein said solid powder is coated with a protective shell.

25. The predoping method of claim 24, wherein said protective shells for different predoping materials have different dissolution times in a solvent.
